(19) United States
(12) Patent Application Publication
(10) Pub. No.: US 2006/0095405 A1
(43) Pub. Date: May 4, 2006

(54) Mirroring database statistics

(75) Inventors: Mark John Anderson, Oronoco, MN (US); Michael S. Faunce, Rochester, MN (US); Brian Robert Muras, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/977,763

(22) Filed: Oct. 29, 2004

(51) Int. Cl. G06F 17/30

(52) U.S. Cl. 707/3

(57) ABSTRACT

Mirroring database statistics, including receiving by a backup application of a backup computer a journal entry representing a requirement for backup database statistics and generating by a statistics engine of the backup computer backup database statistics for a backup database in accordance with the journal entry. Mirroring database statistics according to embodiments of the present invention may also include identifying by an original DBMS of an original database a requirement for backup database statistics and inserting in a database journal by the original DBMS the journal entry representing the requirement for backup database statistics.

### BACKGROUND OF THE INVENTION

1. Field of the Invention

The field of the invention is data processing, or, more specifically, methods, systems, and products for mirroring database statistics.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Information stored on a computer system is often organized in a structure called a database. A database is a grouping of related structures called ‘tables,’ which in turn are organized in rows of individual data elements. The rows are often referred to a ‘records,’ and the individual data elements are referred to as ‘fields.’ In this specification generally, therefore, an aggregation of fields is referred to as a ‘data structure’ or a ‘record,’ and an aggregation of records is referred to as a ‘table.’ An aggregation of related tables is called a ‘database.’

A computer system typically operates according to computer program instructions in computer programs. A computer program that supports access to information in a database is typically called a database management system or a ‘DBMS.’ A DBMS is responsible for helping other computer programs access, manipulate, and save information in a database.

A DBMS typically supports access and management tools to aid users, developers, and other programs in accessing information in a database. One such tool is the structured query language, ‘SQL.’ SQL is query language for requesting information from a database. Although there is a standard of the American National Standards Institute (‘ANSI’) for SQL, as a practical matter, most versions of SQL tend to include many extensions. Here is an example of a database query expressed in SQL:
select*from stores, transactions
where stores.location=“Minnesota”
and stores.storeId=transactions.storeID

This SQL query accesses information in a database by selecting records from two tables of the database, one table named ‘stores’ and another table named ‘transactions.’ The records selected are those having value “Minnesota” in their store location fields and transactions for the stores in Minnesota. In retrieving the data for this SQL query, an SQL engine will first retrieve records from the stores table and then retrieve records from the transaction table. Records that satisfy the query requirements then are merged in a ‘join.’

Databases are very important to the organizations that use them. The term ‘mission critical’ is sometimes applied, meaning that without the database, the organization is critically injured. Because the database is so important, organizations take many measures to be sure it is available for use, even if the system on which it is installed is destroyed by fire, flood, earthquake, explosion, or other disaster. Databases may be backed up by periodic copying to on-site or off-site devices or locations—and databases may be backed up by mirroring.

Mirroring is a real-time incremental replication of data based on journal or log management. That is, mirroring is copying data from an original computer to a backup storage device in real time. In this specification, the backup storage device is referred to generally as a ‘backup computer.’ The term ‘real time’ means that changes in an original database are effected in a backup database at very near the actual time they occur. Because the data is copied in real time, the information stored from the original location is generally an accurate copy of the data from the production device. Data mirroring therefore is intended to provide speedy recovery of data after a failure of an original system—because the backup system is generally identical to the original at all times. Data mirroring can be implemented locally or offsite at a completely different location.

Databases are stores of data, of course, organized in tables, rows, and columns. The data in the tables, row, and columns is the ordinary operational data of direct concern to the users and organizations that rely upon it to run their businesses. Databases contain other data, however, beyond the operational data upon which users rely for business purposes. Databases contain metadata, data about data, data that describes characteristics of other data, including, for example, the operational data of the database. Metadata may describe, for example, how and when and by whom a particular set of operational data was collected, when it was accessed, and how the operational data is formatted. Metadata is essential for understanding information stored in data warehouses and has become increasingly important in XML-based Web applications.

Database statistics are metadata. In a modern DBMS, database statistics are automatically generated by a statistics engine when an attempt to optimize the execution of a query finds useful database statistics missing or stale. Database statistics may include frequency statistics, histogram statistics, and cardinality statistics describing operational data in columns of tables of a database.

Mirroring of database data has not included mirroring of database statistics. That is, traditional mirroring of database data has focused on operational data. Copying database statistics to a backup computer is traditionally a periodic, semi-manual process where a program is run on an original computer to generate a list of required backup database statistics, and then a program is run on the backup computer that takes the list as input and generates required database statistics on the backup computer.

The problem with this approach is that when a user needs to quickly switch over to the backup computer because of a failure on the original computer, many database statistics may be missing or stale. Database performance will be degraded until the backup system eventually generates the required database statistics over time as they are found missing or stale in response to attempts to optimize. Each interruption of optimization on the backup computer to wait for statistics generation represents an additional undesirable burden on system resources.

### SUMMARY OF THE INVENTION

Exemplary methods, systems, and products are described that expand traditional database mirroring to include not only database production data but also database statistics. That is, exemplary methods, systems, and products are described for mirroring database statistics that operate generally by receiving by a backup application of a backup computer a journal entry representing a requirement for backup database statistics and generating by a statistics engine of the backup computer backup database statistics for a backup database in accordance with the journal entry. Mirroring database statistics according to embodiments of the present invention may also include identifying by an original DBMS of an original database a requirement for backup database statistics and inserting in a database journal by the original DBMS the journal entry representing the requirement for backup database statistics.

Identifying a requirement for database statistics may include optimizing execution of an SQL query in dependence upon database statistics for a column of a database and discovering that the database statistics for the column are missing or stale. The backup computer may be located remotely from the original computer and receiving a journal entry representing a requirement for backup database statistics may be carried out by receiving the journal entry through networked digital data communications.

A journal entry may include a journal entry type field that identifies the journal entry as an entry that represents a requirement for backup database statistics and one or more identifier fields that identify a column of a table that requires database statistics. Database statistics may be implemented as metadata of a table. Database statistics typically include histogram ranges and counts of values in histogram ranges, frequencies of occurrence of a values in columns, and cardinalities of values in columns.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary system for mirroring database statistics according to embodiments of the present invention.

FIG. 2 sets forth an additional block diagram of an exemplary system for mirroring database statistics according to embodiments of the present invention.

FIG. 3 sets forth a block diagram of automated computing machinery comprising an exemplary computer useful in mirroring database statistics according to embodiments of the present invention.

FIG. 4 sets forth a flow chart illustrating an exemplary method for mirroring database statistics according to embodiments of the present invention.

FIG. 5A is an illustration of an exemplary database journal for mirroring database statistics according to embodiments of the present invention.

FIG. 5B is an illustration of exemplary database statistics useful for mirroring database statistics according embodiments of the present invention.

### DETAILED DESCRIPTION OF EXEMPLARY EMBODIMENTS

### Glossary of Terms

‘DDL’ refers to Data Definition Language, a set of SQL keywords for DDL that define new tables and associated data elements. Although there is an ANSI standard for DDL, most commercial SQL databases have proprietary extensions in their DDL, which allow control over proprietary and nonstandard, but operationally useful, elements of a specific system.

‘XML’ refers to the eXtensible Markup Language, a specification developed by the World Wide Web Consortium (‘W3C’). XML is a pared-down version of SGML (the Standard Generalized Markup Language). XML was originally intended primarily to encode Web documents, but its use today is much broader than just the Web. It allows designers to create their own customized tags, enabling the definition, transmission, validation, and interpretation of data between applications, between computers and database, and between organizations.

‘RS-232’ is a standard interface approved by the Electronic Industries Alliance (EIA) for connecting serial devices. Almost all modems conform to the EIA-232 standard, and most personal computers have an EIA-232 port for connecting a modem or other device. In addition to modems, many display screens, mice, and serial printers are designed to connect to an EIA-232 port.

‘USB’ abbreviates Universal Serial Bus, an external bus standard that supports data transfer rates of 12 Mbps. A single USB port can be used to connect up to 127 peripheral devices, such as mice, modems, and keyboards. USB also supports Plug-and-Play installation and hot plugging.

‘IEEE 1394’ is a fast external bus standard that supports data transfer rates of up to 400 Mbps (in 1394a) and 800 Mbps (in 1394b). Products supporting the 1394 standard go under different names, depending on the company. Apple, which originally developed the technology, uses the trademarked name ‘FireWire.’ Other companies use other names, such as i.link and Lynx, to describe their 1394 products. A single 1394 port can be used to connect up 63 external devices. In addition to its high speed, 1394 also supports isochronous data—delivering data at a guaranteed rate. This makes it ideal for devices that need to transfer high levels of data in real-time, such as video devices—and mirroring database statistics, for example. ° Like USB, 1394 supports both Plug-and-Play and hot plugging, and also provides power to peripheral devices.

An Ethernet™ is local-area network (‘LAN’) architecture developed by Xerox Corporation in cooperation with DEC and Intel. Ethernet uses a bus or star topology and supports data transfer rates of 10 Mbps. The Ethernet specification served as the basis for the IEEE 802.3 standard, which specifies the physical and lower software layers of a data communications protocol stack. Ethernet is a widely used implemented LAN standard.

‘IP’ stands for Internet Protocol. IP specifies the format of data packets, a data communications protocol for transmitting the packets among computers, and a network addressing scheme. Most networks that use IP combine it with a higher-level protocol called Transmission Control Protocol (‘TCP’), which establishes a virtual connection between a destination and a source. IP and TCP are so often used together that they are often referred to simply as TCP/IP.

‘HTTP’ stands for HyperText Transfer Protocol, the principal data communications protocol of by the World Wide Web. HTTP functions in the application layer of the ISO data communications protocol stack. HTTP implementations often use TCP in the transport layer and IP in the network layer of the stack.

### Mirroring Database Statistics

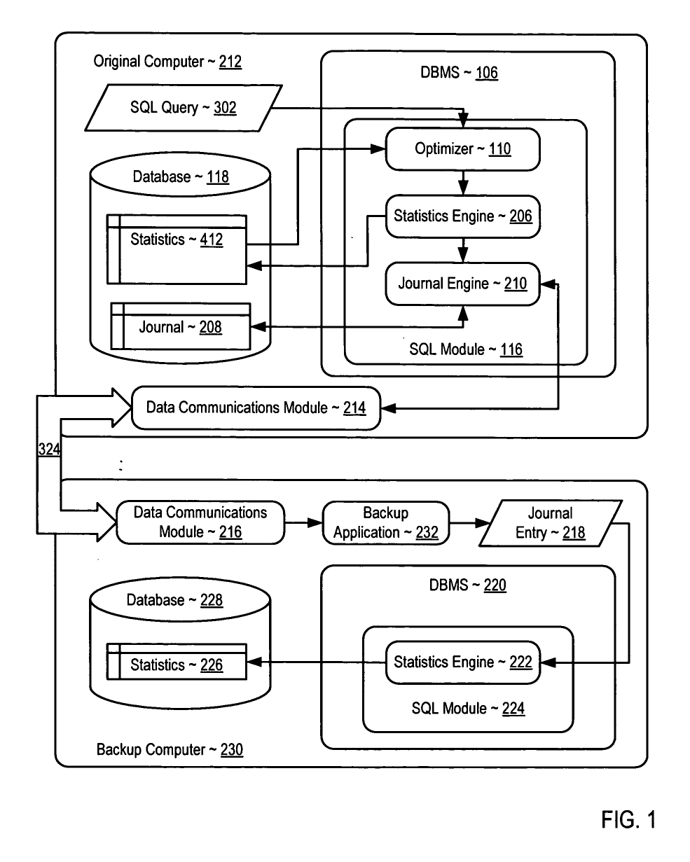

Exemplary methods, systems, and products for mirroring database statistics according to embodiments of the present invention are explained with reference to the accompanying drawings, beginning with FIG. 1. FIG. 1 sets forth a block diagram of an exemplary system for mirroring database statistics according to embodiments of the present invention. The system of FIG. 1 includes an original computer (212) and a backup computer (230) connected for data communications through communications channel (324). Computer (230) is a ‘backup computer’ in the sense that its resources are used to mirror the contents of original database (118) of original computer (212). Computer (212) is labeled an ‘original computer’ in this specification to signify that the contents of its database (118) are an original of which the contents of database (228) on the backup computer are a copy.

The system of FIG. 1 illustrated a system architecture, with original computer (212) coupled to backup computer (230) through data communications channel (324). This exact architecture, however, is presented only for explanation, not for limitation of the present invention. Many system architectures as will occur to those of skill in the art are functional for mirroring database statistics according to embodiments of the present invention, and all such architectures are well within the scope of the present invention. Examples include:
an architecture in which original computer (212) and backup computer (230) are implemented on the same overall computer system, as separate threads of execution on the same processor or on separate processors, for example, with communications channel (324) implemented as shared memory segments or a shared data bus;
an architecture in which original computer (212) and backup computer (230) are implemented as separate computers in close proximity, in the same building or even the same room, with communications channel (324) implemented as an RS-232, USB, or Firewire connection; and
an architecture in which original computer (212) and backup computer (230) are implemented as separate computers with original computer (212) located remotely from backup computer (230) with communications channel (324) implemented with a wireless modem, wireless Ethernet, TCP/IP, and HTTP; remote locations may include anywhere on Earth, Earth orbit, or even a deep space vehicle.

The exemplary original computer of FIG. 1 includes an SQL module (116). The SQL module is implemented as computer program instructions that execute an SQL query (302). The system of FIG. 1 includes optimizer (110) as part of the SQL module. Optimizer (110) optimizes the execution of SQL queries against original DBMS (106). DBMS (106) is a DBMS that administers access to the contents of original database (118). Optimizer (110) is implemented as computer program instructions that optimize execution of a SQL query in dependence upon database management statistics. Optimizer (110) is capable of optimizing execution of an SQL query in dependence upon database statistics for a column of a database and discovering that the database statistics for the column are missing or stale. Database statistics may reveal, for example, that there are only two zip code values in a user account table—so that it is an optimization, that is, more efficient, to scan the user account table rather than using index access. Alternatively, database statistics may reveal that there are many user account records, only a few of which have zip code values in a range of interest—so that for a particular SQL query it is an optimization to access the user account table by an index.

Database statistics are typically implemented as metadata of a table, such as, for example, metadata of tables of database (118). Database statistics may include, for example:
histogram statistics: a histogram range and a count of values in the range,
frequency statistics: a frequency of occurrence of a value in a column, and
Cardinality statistics: a count of the number of different values in a column.

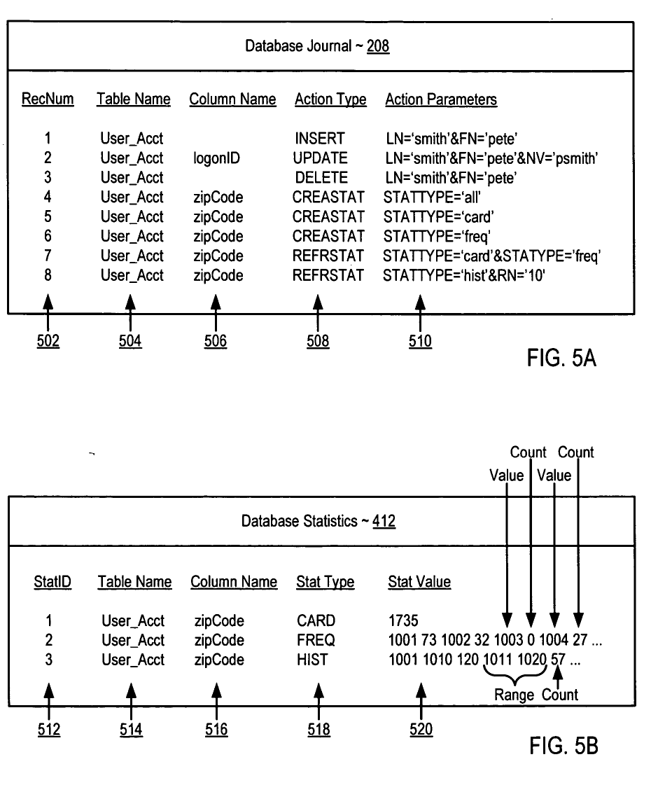

These three database statistics are presented for explanation only, not for limitation. The use of any database statistics as will occur to those of skill in the art is well within the scope of the present invention. Database statistics are further explained below with respect to FIG. 5B.

Optimizer (110) uses database statistics (412) from database (118) for optimizing SQL queries against database (118). Optimizer (110) notifies statistics engine (206) when the optimizer attempts to use databases statistics for a column of a table, for example, and finds the database statistics missing or stale. Statistics engine (206) generates the missing or stale statistics and notifies journal engine (210) to insert in a database journal a journal entry representing a requirement for backup database statistics. Journal entries in journal (208) are made available for retrieval by a backup computer through journal engine (210) and data communications module (214).

The system of FIG. 1 includes a backup application (232) of a backup computer (230), the backup application having a capability of receiving a journal entry (218). Backup application (232) is implemented as computer program instructions that receive by a backup application of a backup computer a journal entry representing a requirement for backup database statistics. The backup computer includes a backup data communications module (216) capable of receiving the journal entry (218) representing a requirement for backup database statistics from an original computer through digital data communications (324) and passing the journal entry (218) to the backup application (232). The backup application typically communicates with the backup data communications module through an API of the data communications module. If the data communications module supports a sockets API for TCP/IP, for example, then the backup applications will communication with the data communications module through sockets calls.

The system of FIG. 1 also includes a statistics engine (222) of the backup computer (230) implemented as computer program instructions that generates backup database statistics (226) for a backup database (228) in accordance with a journal entry (218). In this example, journal entry (218) represents a requirement for backup database statistics (226). A journal entry may include a journal entry type field that identifies the journal entry as an entry that represents a requirement for backup database statistics as well as one or more identifier fields that identify a column of a table that requires database statistics. Journal entries for mirroring database statistics according to embodiments of the present invention may include many other data elements or fields also as will occur to those of skill in the art. Journal entries for mirroring database statistics according to embodiments of the present invention are further explained below with respect to FIG. 5A.

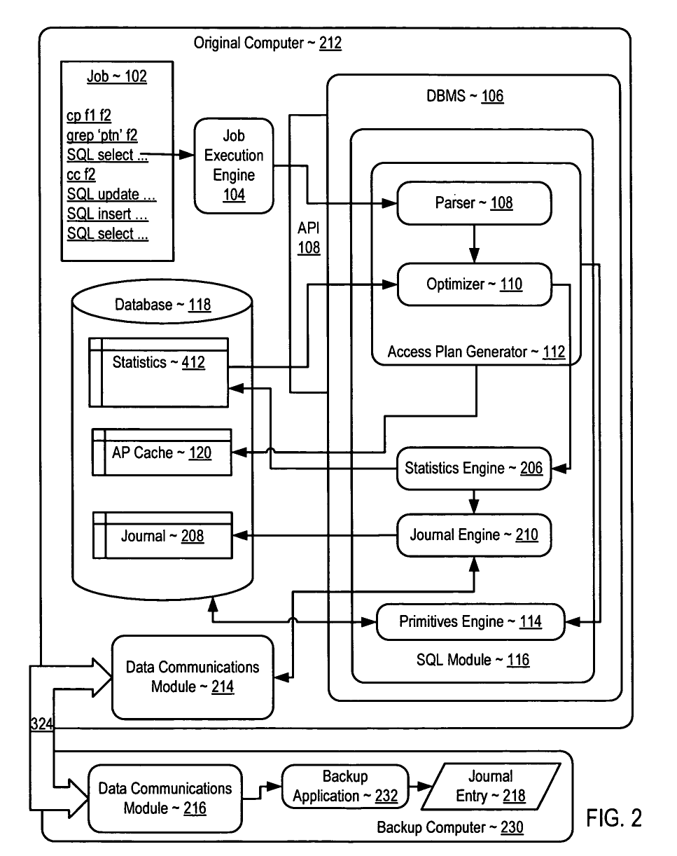

For further explanation, FIG. 2 sets forth an additional block diagram of an exemplary system for mirroring database statistics according to embodiments of the present invention. In addition to the system elements that were described above with respect to FIG. 1, original computer (212), backup computer (230), data communications modules (214, 216), data communications channel (324), and so on. The system of FIG. 2 includes some elements not discussed with respect to FIG. 1, and some of the elements shown in FIG. 1 are described in more detail with respect to FIG. 2.

The exemplary system of FIG. 2 includes an SQL module (116). The SQL module is implemented as computer program instructions that execute an SQL query. In the example of FIG. 2, SQL module (116) receives SQL queries for execution from job execution engine (104). Job execution engine (104) is a software module that executes job, such as job (102), by passing commands from the jobs to software applications appropriate to the command. Jobs may mingle SQL queries with other commands to perform various data processing tasks. Job (102), for example, includes several commands for execution as part of job (102), including:
cp f1 f2: an operating system command to copy one file to another file.
grep ‘ptn’ f2: a general regular expression command of the operating system to find occurrences of ‘ptn’ in file f2,
cc f2: a command to compile file f2 as a C program, and
several SQL commands, each of which passes as a parameter to an executable command named ‘SQL’ call parameters identifying an SQL query.

In this example, job execution engine (104) will pass the operating system commands from job (102) to the operating system for execution and pass the SQL queries from job (102) to SQL module (116) for execution. Job execution engine (104) passes the SQL queries to SQL module (116) through application programming interface (‘API’) (108) of database management system (‘DBMS’) (106). DBMS (106) provides database management functions for database (118). DBMS (106) exposes API (108) to enable applications, including, for example, job execution engine (104) to access functions of the DBMS, including, for example, SQL module (116). The ‘SQL’ command illustrated in job (102) is a function made available through API (108).

The exemplary SQL module (116) of FIG. 2 includes an exemplary access plan generator (112). Each SQL query is carried out by a sequence of database operations specified as an access plan. The access plan generator of FIG. 2 is implemented as computer program instructions that create an access plan for a SQL query. An access plan is a description of database functions for execution of an SQL query. Taking the following SQL query as an example:
select * from stores, transactions
where stores.storeID=transactions.storeID,
   access plan generator (112) may generate the following exemplary access plan for this SQL query:
tablescan stores
join to
index access of transactions
   This access plan represents database functions to scan through the stores table and, for each stores record, join all transactions records for the store. The transactions for a store are identified through the storeID field acting as a foreign key. The fact that a selection of transactions records is carried out for each store record in the stores table identifies the join function as iterative.

The exemplary access plan generator (112) of FIG. 2 includes a parser (108) for parsing the SQL query. Parser (108) is implemented as computer program instructions that parse the SQL query. AN SQL query is presented to SQL module (116) in text form, the parameters of an SQL command. Parser (108) retrieves the elements of the SQL query from the text form of the query and places them in a data structure more useful for data processing of an SQL query by an SQL module.

The exemplary access plan generator (112) also includes an optimizer (110) implemented as computer program instructions that optimize the access plan in dependence upon database management statistics. Database statistics may reveal, for example, that there are only two storeID values in the transactions table—so that it is an optimization, that is, more efficient, to scan the transactions table rather than using an index. Alternatively, database statistics may reveal that there are many transaction records with only a few transactions records for each storeID—so that it is an optimization, that is, more efficient, to access the transactions records by an index.

The exemplary SQL module (116) of FIG. 2 includes a primitives engine (114) implemented as computer program instructions that execute primitive query functions in dependence upon the access plan. A ‘primitive query function,’ or simply a ‘primitive,’ is a software function that carries out actual operations on a database, retrieving records from tables, inserting records into tables, deleting records from tables, updating records in tables, and so on. Primitives correspond to parts of an access plan and are identified in the access plan. Examples of primitives include the following database instructions:
retrieve the next three records from the stores table into hash table H1
retrieve one record from the transactions table into hash table H2
join the results of the previous two operations
store the result of the join in table T1

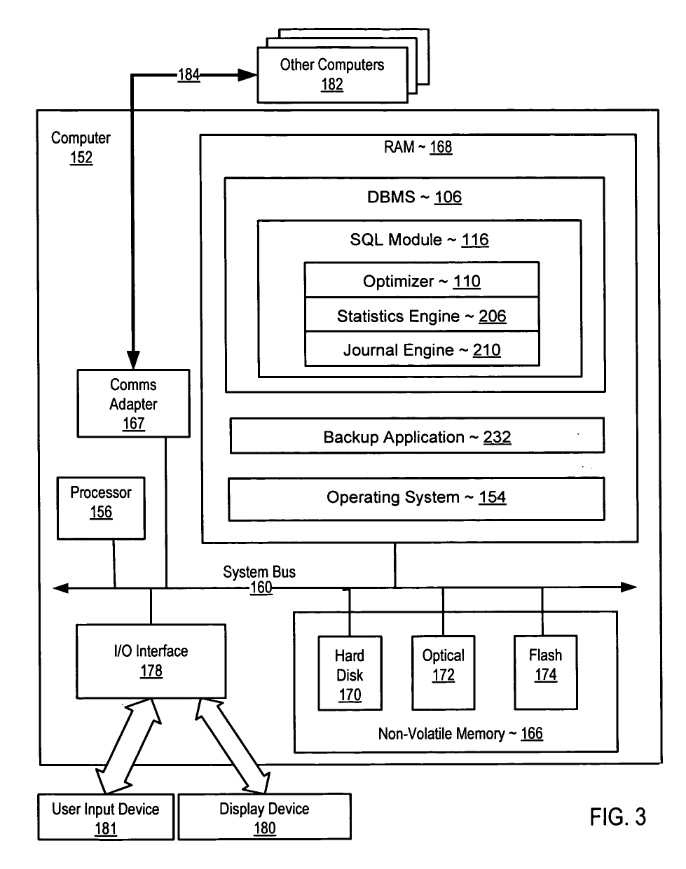

As mentioned above, mirroring database statistics in accordance with the present invention is generally implemented with computers, that is, with automated computing machinery. For further explanation, FIG. 3 sets forth a block diagram of automated computing machinery comprising an exemplary computer (152) useful in mirroring database statistics according to embodiments of the present invention. The computer (152) of FIG. 3 includes at least one computer processor (156) or ‘CPU’ as well as random access memory (168) (“RAM”) which is connected through a system bus (160) to processor (156) and to other components of the computer. Stored in RAM (168) is DBMS (106), computer program instructions for database management. The DBMS (106) of FIG. 3 includes an SQL module (116), which in turn includes an optimizer (110), a statistics engine (206), and a journal engine (210), each of which implement computer program instructions stored in RAM (168) that operate computer (152) as described above. Also stored in RAM (168) is a backup application (232), computer program instructions that receive journal entries representing requirements for backup database statistics.

Also stored in RAM (168) is an operating system (154). Operating systems useful in computers according to embodiments of the present invention include UNIX™, Linux™, Microsoft NT™, AIX™, IBM's i5os, and many others as will occur to those of skill in the art. Operating system (154), DBMS (106), and backup application (232) in the example of FIG. 3 are shown in RAM (154), but many components of such software typically are stored in non-volatile memory (166) also.

Computer (152) of FIG. 3 includes non-volatile computer memory (166) coupled through a system bus (160) to processor (156) and to other components of the computer. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 3 includes a communications adapter (167) for implementing connections for data communications (184) to other computers (182). Such connections may include serial connections such as RS-232 connections, connections through external buses such as USB connections, connections through data communications networks such as TCP/IP connections, and others as will occur to those of skill in the art. Communications adapters implement the hardware level of connections for data communications through which one computer sends data communications another computer, directly or through a network. Examples of communications adapters useful for mirroring database statistics according to embodiments of the present invention include modems for wired dial-up connections, Ethernet (IEEE 802.3) adapters for wired network connections, and 802.11b adapters for wireless network connections.

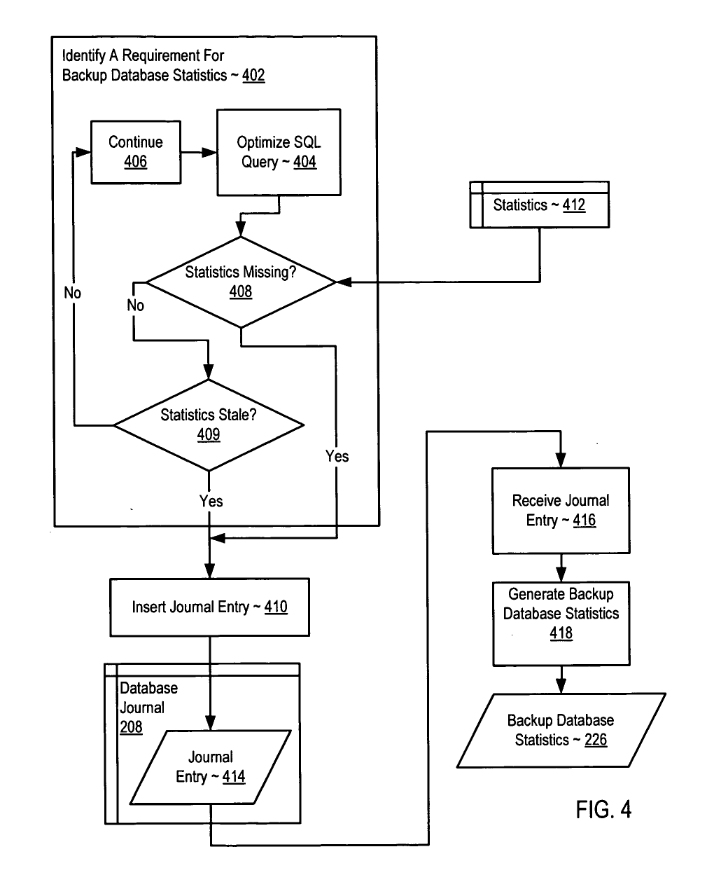

For further explanation, FIG. 4 sets forth a flow chart illustrating an exemplary method for mirroring database statistics according to embodiments of the present invention that includes identifying (402) by an original DBMS of an original database a requirement for backup database statistics. In the method of FIG. 4, identifying (402) a requirement for backup database statistics is carried out by optimizing (404) execution of an SQL query in dependence upon database statistics for a column of a database; and, in the process of optimizing the SQL query, discovering that the database statistics for the column are missing (408) or stale (409). In the method of FIG. 4, if database statistics useful for optimizing an SQL query are missing, the method continues by inserting (410) in a database journal by an original DBMS a journal entry (414) representing a requirement for backup database statistics. If statistics database statistics useful for optimizing an SQL query are available, that is, not missing, the method of FIG. 4 includes determining (409) whether the database statistics are stale. If the statistics are not stale, optimization continues (404) by use of the statistics. If the statistics are stale, the method of FIG. 4 continues by inserting (410) in a database journal by an original DBMS a journal entry (414) representing a requirement for backup database statistics. That is, the method of FIG. 4 includes inserting (410) in a database journal by an original DBMS a journal entry (414) representing a requirement for backup database statistics if an optimization process finds useful database statistics missing or stale.

The method of FIG. 4 also includes receiving (416) by a backup application of a backup computer a journal entry (414) representing a requirement for backup database statistics (226) and generating (418) by a statistics engine of the backup computer backup database statistics (414) for a backup database in accordance with the journal entry (414). In the method of FIG. 4, the backup computer may be located remotely from the original computer and receiving a journal entry representing a requirement for backup database statistics may include receiving a journal entry through networked digital data communications.

In the method of FIG. 4, the journal entry may include a journal entry type field that identifies the journal entry as an entry that represents a requirement for backup database statistics and one or more identifier fields that identify a column of a table that requires database statistics. In the method of FIG. 4, database statistics may be implemented as metadata of a table. In the method of FIG. 4, database statistics may include a histogram range and a count of values in the range, a frequency of occurrence of a value in a column, and cardinality of values in a column.

For further explanation, FIG. 5A is an illustration of an exemplary database journal (208) for mirroring database statistics according to embodiments of the present invention. The exemplary journal of FIG. 5A is illustrated as a table with records. Illustrating the exemplary journal of FIG. 5A as a table is for convenience of explanation, not a limitation of the present invention. A database journal may be represented in many data forms and structures within the scope of the present invention including, for example, plain text, XML, SGML, and in other ways as will occur to those of skill in the art.

Each record of database journal (208) represents a database journal entry describing a change in a database or a requirement for backup database statistics. Such changes are represented by the SQL queries INSERT, UPDATE, and DELETE, as well as journal entries representing requirements for backup database statistics. The record of database journal (208) have columns representing a record number (502), a table name (504) of a table in which a change has occurred or for which backup database statistics are required, a column name (506) of a column in which a change has occurred or for which backup database statistics are required, an action type (508) indicating the type of change that occurred or whether backup database statistics are to be created or refreshed, and action parameters (510) encoding parameter data needed to carry out a change or creation of backup database statistics in a backup computer.

The action parameters (510) are encoded in name-value pairs. The encoding in name-value pairs is for explanation only, not a limitation of the present invention. Alternative encoding schemes within the scope of the invention include, for example, encodings in DDL, XML, and other encoding schemes as will occur to those of skill in the art. One alternative way to encode the SQL queries effecting changes is to include the entire original SQL query as a text string for execution in an SQL engine of a backup computer. The name-value pair encoding is useful in this example, however, because it may be applied to both the SQL queries affecting changes as well as the journal entries represented requirements for backup database statistics.

Records number 1-3 are journal entries representing changes in database data. Record number 1 in database journal (208) represents a change, insertion of a new database record in a table named ‘User_Acct’ for a user with last name Smith and first name Pete. The user's name is encoded in name-value pairs where LN represents the user's last name and FN represents the user's first name as: LN=‘smith’&FN=‘pete’. Record number 2 in database journal (208) represents a change, updating a record the ‘User_Acct’ table to insert a new logon identification (‘logonID’) for a user with last name Smith and first name Pete. The user's name is included in the journal entry to enable a backup SQL module to find the record to be updated. The name of the column to be updated is in the ‘Column Name’ (506) record number 2. The new value of the logonID is encoded in the name-value pair: NV=‘psmith’. Record number 3 in database journal (208) represents another change, deletion of the ‘User_Acct’ record for the user with last name Smith and first name Pete.

Records 4-8 are journal entries representing requirements for backup database statistics. Record number 4 is a journal entry that represents a requirement to generate all supported types of database statistics for a column named ‘zipCode’ in a table named ‘User_Acct.’ The statistics type ‘all’ is encoded in the name-value pair: STATTYPE=‘all’. Record number 5 is a journal entry that represents a requirement to generate cardinality statistics for a column named ‘zipCode’ in a table named ‘User_Acct.’ The cardinality statistics type is encoded in the name-value pair: STATTYPE=‘card’. Record number 6 is a journal entry that represents a requirement to generate frequency statistics for a column named ‘zipCode’ in a table named ‘User_Acct.’ The frequency statistics type is encoded in the name-value pair: STATTYPE=‘freq’. Record number 7 is a journal entry that represents a requirement to generate cardinality and frequency statistics for a column named ‘zipCode’ in a table named ‘User_Acct.’ The statistics types are encoded in the name-value pairs: STATTYPE=‘card’ &STATTYPE=‘freq’.

Record number 8 in the database journal (208) is a journal entry that represents a requirement to generate histogram statistics for a column named ‘zipCode’ in a table named ‘User_Acct.’ The histogram statistics type is encoded in the name-value pair: STATTYPE=‘hist’. The action parameters (510) for record number 8 also include a data value range for the histogram encoded as: RN=‘10’. The inclusion of the data value range for the histogram within the journal entry itself is optional, presented here for ease of explanation, not as a limitation of the invention. Alternatively, an optimization engine may be configured with operating parameters that include data value ranges for histogram statistics. Or an optimization engine may be programmed to determine histogram ranges algorithmically, for example, by determining the overall range of values in a column of data and dividing the overall range into a predetermined number of equal histogram ranges. Other ways of specifying or determining histogram ranges may occur to those of skill in the art, and all such ways are well within the scope of the present invention.

A backup computer, upon receiving journal entries representing requirements for backup statistics as illustrated in FIG. 5A, passes the journal entries to a backup statistics engine which uses the journal entries to generate backup database statistics as illustrated in FIG. 5B. FIG. 5B is an illustration of exemplary database statistics useful for mirroring database statistics according embodiments of the present invention. The example of FIG. 5B illustrates exemplary database statistics (412) for a column named ‘zipCode’ (516) in a table named User_Acct (514). The exemplary database statistics of FIG. 5B are illustrated as a table with records. Illustrating the exemplary database statistics of FIG. 5B as a table is for convenience of explanation, not a limitation of the present invention. Database statistics may be represented in many data forms and structures within the scope of the present invention including, for example, plain text, XML, SGML, and in other ways as will occur to those of skill in the art.

Each record in the exemplary database statistics of FIG. 5B represents a database statistic or a set of database statistics. Each record is identified with a record number referred to as ‘statID’ (512). Each record includes a column to identify the type (518) of statistic in the record and a column in which the statistic is stored (520). Statistic number 1 in the exemplary database statistics of FIG. 5B is a cardinality statistic that may be generated, for example, upon receiving in a backup computer a journal entry representing a requirement for backup database statistics similar to record number 5 in the database journal (208) of FIG. 5A. Statistic number 1 has a statistics value (520) of 1735, representing the number of zip codes in the User_Acct table.

Statistic number 2 in the exemplary database statistics of FIG. 5B is a frequency statistic that may be generated, for example, upon receiving in a backup computer a journal entry representing a requirement for backup database statistics similar to record number 6 in the database journal (208) of FIG. 5A. Statistic number 2 has a statistics value (520) of:
1001 73 1002 32 1003 0 1004 27 . . .
   This value of statistic number 2 represents a count of the number of records in the User_Acct table having each zip code in the table, encoded as: zipCode count zipCode count zipCode count . . . . The value of statistic number 2, therefore, represents 73 occurrences of the zip code ‘1001,’ 32 occurrences of the zip code ‘1002,’ 0 occurrences of the zip code ‘1003,’ 27 occurrences of the zip code ‘1004,’ and so on.***

Statistic number 3 in the exemplary database statistics of FIG. 5B is a histogram statistic that may be generated, for example, upon receiving in a backup computer a journal entry representing a requirement for backup database statistics similar to record number 7 in the database journal (208) of FIG. 5A. Statistic number 3 has a statistics value (520) of:
1001 1010 120 1011 1020 57 . . .

This value of statistic number 3 represents a count of the number of records in the User_Acct table having zip codes in a range of 10 zip codes, encoded as: begZipCode endZipCode count begZipCode endZipCode count begZipCode endZipCode count . . . . In this example, begZipCode and endZipCode represent respectfully the beginning zip code value and the ending zip code value in a histogram value range of zip codes. The value of statistic number 3, therefore, represents 120 occurrences of zip code values in the range 1001-1010,′ 57 occurrences of zip code values in the range 1011-1020,′ and so on. The inclusion of the histogram data value range within the database statistic itself is optional, presented here for ease of explanation, not as a limitation of the invention. As mentioned above in the explanation of journal entry number 8 in database journal (208) of FIG. 5A, it is alternative to configure an optimization engine with operating parameters that include histogram data value ranges. Or an optimization engine may be programmed to determine histogram ranges algorithmically, for example, by determining the overall range of values in a column of data and dividing the overall range into a predetermined number of equal histogram ranges. Other ways of specifying or determining histogram ranges may occur to those of skill in the art, and all such ways are well within the scope of the present invention.

Exemplary embodiments of the present invention are described largely in the context of fully functional computer systems for mirroring database statistics. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets and networks that communicate with the Internet Protocol and the World Wide Web. Persons skilled in the art will recognize that any computer system having suitable programming means will be capable of executing the steps of the method of the invention as embodied in a program product. Persons skilled in the art will recognize that, although most of the exemplary embodiments described in this specification are oriented to software installed and executing on computer hardware, nevertheless, alternative embodiments implemented as firmware or as hardware are well within the scope of the present invention.

In view of the explanation set forth above in this specification, readers now should recognize that the benefits of mirroring database statistics according to embodiments of the present invention include:
maintenance of backup database statistics for a backup database on a backup computer system so that the backup computer system is configured optimally for performance whenever it becomes necessary to switch to it, and
the data processing requirements of identifying requirements for backup database statistics and generating backup database statistics on the backup computer is spread out over time so that there is no single, large workload required to collect and update statistics as is necessary with the periodic, semi-manual approach of the prior art.
   It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for mirroring database statistics, the method comprising:
receiving by a backup application of a backup computer a journal entry representing a requirement for backup database statistics; and
generating by a statistics engine of the backup computer backup database statistics for a backup database in accordance with the journal entry.

2. The method of claim 1 further comprising:
identifying by an original DBMS of an original database a requirement for backup database statistics; and
inserting in a database journal by the original DBMS the journal entry representing the requirement for backup database statistics.

3. The method of claim 2 wherein identifying a requirement for database statistics further comprises:
optimizing execution of an SQL query in dependence upon database statistics for a column of a database; and
discovering that the database statistics for the column are missing or stale.

4. The method of claim 1 wherein:
the backup computer is located remotely from the original computer, and
receiving a journal entry representing a requirement for backup database statistics further comprises receiving a journal entry through networked digital data communications.

5. The method of claim 1 wherein the journal entry further comprises:
a journal entry type field that identifies the journal entry as an entry that represents a requirement for backup database statistics, and
one or more identifier fields that identify a column of a table that requires database statistics.

6. The method of claim 1 wherein database statistics comprise metadata of a table.

7. The method of claim 1 wherein database statistics comprise a histogram range and a count of values in the range.

8. The method of claim 1 wherein database statistics comprise a frequency of occurrence of a value in a column.

9. The method of claim 1 wherein database statistics comprise cardinality of values in a column.

10. Apparatus for mirroring database statistics, the apparatus comprising:
a computer processor;
a computer memory coupled for data transfer to the processor, the computer memory having disposed within it computer program instructions comprising:
a backup application of a backup computer, the backup application having a capability of receiving a journal entry representing a requirement for backup database statistics; and
a statistics engine of the backup computer, the statistics engine having a capability of generating backup database statistics for a backup database in accordance with the journal entry.

11. The apparatus of claim 10 further comprising an optimizer of an original DBMS of an original database, the optimizer having capabilities of:
optimizing execution of an SQL query in dependence upon database statistics for a column of a database; and
discovering that the database statistics for the column are missing or stale.

12. The apparatus of claim 10 wherein:
the backup computer is located remotely from the original computer, and
the backup computer includes a backup data communications module that has capabilities of receiving the journal entry representing a requirement for backup database statistics through digital data communications and passing the journal entry to the backup application.

13. The apparatus of claim 10 wherein the journal entry further comprises:
a journal entry type field that identifies the journal entry as an entry that represents a requirement for backup database statistics, and
one or more identifier fields that identify a column of a table that requires database statistics.

14. The apparatus of claim 10 wherein database statistics comprise metadata of a table.

15. The apparatus of claim 10 wherein database statistics comprise a histogram range and a count of values in the range.

16. The apparatus of claim 10 wherein database statistics comprise a frequency of occurrence of a value in a column.

17. The apparatus of claim 10 wherein database statistics comprise cardinality of values in a column.

18. A system for mirroring database statistics, the system comprising:
means for receiving by a backup application of a backup computer a journal entry representing a requirement for backup database statistics; and
means for generating by a statistics engine of the backup computer backup database statistics for a backup database in accordance with the journal entry.

19. The system of claim 18 further comprising:
means for identifying by an original DBMS of an original database a requirement for backup database statistics; and
means of the original DBMS for inserting in a database journal the journal entry representing the requirement for backup database statistics.

20. The system of claim 19 wherein means for identifying a requirement for database statistics further comprises:
means for optimizing execution of an SQL query in dependence upon database statistics for a column of a database; and
means for discovering that the database statistics for the column are missing or stale.

21. The system of claim 18 wherein:
the backup computer is located remotely from the original computer, and
means for receiving a journal entry representing a requirement for backup database statistics further comprises means for receiving a journal entry through networked digital data communications.

22. The system of claim 18 wherein the journal entry further comprises:
a journal entry type field that identifies the journal entry as an entry that represents a requirement for backup database statistics, and
one or more identifier fields that identify a column of a table that requires database statistics.

23. The system of claim 18 wherein database statistics comprise metadata of a table.

24. The system of claim 18 wherein database statistics comprise a histogram range and a count of values in the range.

25. The system of claim 18 wherein database statistics comprise a frequency of occurrence of a value in a column.

26. The system of claim 18 wherein database statistics comprise cardinality of values in a column.

27. A computer program product for mirroring database statistics, the computer program product disposed upon a signal bearing medium, the computer program product comprising:
computer program instructions that receive by a backup application of a backup computer a journal entry representing a requirement for backup database statistics; and
computer program instructions that generate by a statistics engine of the backup computer backup database statistics for a backup database in accordance with the journal entry.

28. The computer program product of claim 22 wherein the signal bearing medium comprises a recordable medium.

29. The computer program product of claim 22 wherein the signal bearing medium comprises a transmission medium.

30. The computer program product of claim 27 further comprising:
computer program instructions of an original DBMS that identify a requirement for backup database statistics; and
computer program instructions of the original DBMS that insert in a database journal the journal entry representing the requirement for backup database statistics.

31. The computer program product of claim 28 wherein computer program instructions that identify a requirement for database statistics further comprises:
computer program instructions that optimize execution of an SQL query in dependence upon database statistics for a column of a database; and
computer program instructions that discover that the database statistics for the column are missing or stale.

32. The computer program product of claim 27 wherein:
the backup computer is located remotely from the original computer, and
computer program instructions that receive a journal entry representing a requirement for backup database statistics further comprises computer program instructions that receive a journal entry through networked digital data communications.

33. The computer program product of claim 27 wherein the journal entry further comprises:
a journal entry type field that identifies the journal entry as an entry that represents a requirement for backup database statistics, and
one or more identifier fields that identify a column of a table that requires database statistics.

34. The computer program product of claim 27 wherein database statistics comprise metadata of a table.

35. The computer program product of claim 27 wherein database statistics comprise a histogram range and a count of values in the range.

36. The computer program product of claim 27 wherein database statistics comprise a frequency of occurrence of a value in a column.

37. The computer program product of claim 27 wherein database statistics comprise cardinality of values in a column.
